(19) United States
(12) Patent Application Publication
(10) Pub. No.: US 2025/0390943 A1
(43) Pub. Date: Dec. 25, 2025

(54) SYSTEMS AND METHODS FOR RECOMMENDING A BUY NOW, PAY LATER OFFER

(71) Applicant: Mastercard International Incorporated, Purchase, NY (US)

(72) Inventors: Yogesh Chopade, Pune (IN); Asif Kadiwala, Vadodara (IN); Hetvik Shah, Vadodara (IN); Mithilesh Jayantrao Deshpande, Livingston, NJ (US); Semal Gajera, Vadodara (IN); Vikas Chandra, Pune (IN)

(73) Assignee: Mastercard International Incorporated, Purchase, NY (US)

(21) Appl. No.: 18/752,947

(22) Filed: Jun. 25, 2024

(51) Int. Cl. G06Q 40/03; G06Q 20/24

(52) U.S. Cl. CPC G06Q 40/03; G06Q 20/24

(57) ABSTRACT

A system for recommending Buy Now, Pay Later (BNPL) offers receives a request for the recommended BNPL loan offers. The request is associated with a transaction. The system retrieves a BNPL loan offer similarity matrix and a transaction similarity matrix from a database. The system also retrieves consumer historical transaction records associated with the consumer from the database. Using the transaction data, the BNPL loan offer similarity matrix, and the transaction similarity matrix, the system performs both a content-based recommendation calculation and an experience-based recommendation calculation. The system then produces the recommended BNPL loan offers based on the results of the two calculations and transmits the recommended BNPL loan offers to a merchant for completing the transaction.

### BACKGROUND

The present invention relates generally to installment loans and, more particularly, to recommending Buy Now, Pay Later installment loans to a consumer based on one or more artificial intelligence (AI) models trained on past transaction patterns.

Buy Now, Pay Later (BNPL) loans have gained significant popularity in recent years as an alternative payment method for consumers. The concept behind BNPL is relatively simple: it allows customers to make a purchase and defer the payment over a specified period, typically in multiple installments. Instead of paying the full price upfront, consumers can split their payments into more manageable chunks, often with little to no interest if the installments are paid on time. Because more installment program providers (IPPs) and merchants are participating in offering BNPL products, with the numbers of participants only increasing, it is difficult for consumers to identify BNPL offers most suitable for their particular situation or preference.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a Buy Now, Pay Later (BNPL) offer recommendation service system is provided. The system includes a database, at least one processor coupled to the database, and a memory device. The database stores a BNPL loan offer similarity matrix, a transaction similarity matrix, and historical transaction data thereon. The historical transaction data includes a plurality of consumer historical transaction records associated with a plurality of consumers. The memory device stores computer-executable instructions thereon. The computer-executable instructions cause the at least one processor to receive, from a computer associated with a merchant, a request for one or more recommended BNPL loan offers. The request is associated with a transaction being performed by a consumer. The at least one processor retrieves, from the database, the BNPL loan offer similarity matrix and the transaction similarity matrix and retrieves, from the historical transaction data on the database, one or more consumer historical transaction records associated with the consumer. The one or more consumer historical transaction records include only transaction records for transactions performed by the consumer using a BNPL loan offer. The at least one processor performs a content-based recommendation calculation using the one or more consumer historical transaction records and the BNPL loan offer similarity matrix and performs an experience-based recommendation calculation using the transaction data, the BNPL loan offer similarity matrix, and the transaction similarity matrix. Furthermore, the at least one processor produces the one or more recommended BNPL loan offers based on results of the content-based recommendation calculation and the experience-based recommendation calculation and transmits the one or more recommended BNPL loan offers to the computer associated with a merchant.

In another aspect, a computer-implemented method is provided. The method includes receiving from a computer associated with a merchant, a request for one or more recommended BNPL loan offers. The request is associated with a transaction being performed by a consumer. The method also includes retrieving, from a database, a BNPL loan offer similarity matrix and a transaction similarity matrix. The database stores the BNPL loan offer similarity matrix, the transaction similarity matrix, and historical transaction data. The historical transaction data includes a plurality of consumer historical transaction records associated with a plurality of consumers. The method includes retrieving, from the historical transaction data stored on the database, one or more consumer historical transaction records associated with the consumer. The one or more consumer historical transaction records include only transaction records for transactions performed by the consumer using a BNPL loan offer. In addition, the method includes performing a content-based recommendation calculation using the one or more consumer historical transaction records and the BNPL loan offer similarity matrix. The method also includes performing an experience-based recommendation calculation using the transaction data, the BNPL loan offer similarity matrix, and the transaction similarity matrix. Moreover, the method includes producing the one or more recommended BNPL loan offers based on results of the content-based recommendation calculation and the experience-based recommendation calculation. Furthermore, the method includes transmitting the one or more recommended BNPL loan offers to the computer associated with a merchant.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an exemplary system for recommending Buy Now, Pay Later (BNPL) financing products, in accordance with an aspect of the present invention;

FIG. 2 is an example configuration of a user computing system for use with the system shown in FIG. 1;

FIG. 3 is an example configuration of a server system for use with the system shown in FIG. 1;

FIG. 4 is an example configuration of a recommendation system for use with the system shown in FIG. 1;

FIG. 5 is a flowchart illustrating an exemplary computer-implemented method for registering a consumer for a BNPL offer recommendation service, in accordance with one embodiment of the present disclosure;

FIG. 6 is a flowchart illustrating an exemplary computer-implemented method for completing a transaction with a recommended Buy Now, Pay Later (BNPL) offer made available to a consumer, in accordance with one embodiment of the present disclosure;

FIG. 7 is a flowchart illustrating an exemplary computer-implemented method for recommending one or more BNPL loan offers;

FIG. 8 is a flowchart illustrating an exemplary computer-implemented method for generating a similarity matrix, in accordance with one embodiment of the present disclosure; and

FIG. 9 schematically depicts similarity matrices generated by embodiments of the disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

The embodiments of the invention use historical transaction data representing a plurality of transaction records. The transaction data may be acquired by a payment network (such as a payment card network), during the course of a series of transactions between issuing banks operating financial accounts on behalf of consumers and acquiring banks operating financial accounts on behalf of merchants.

### Exemplary System

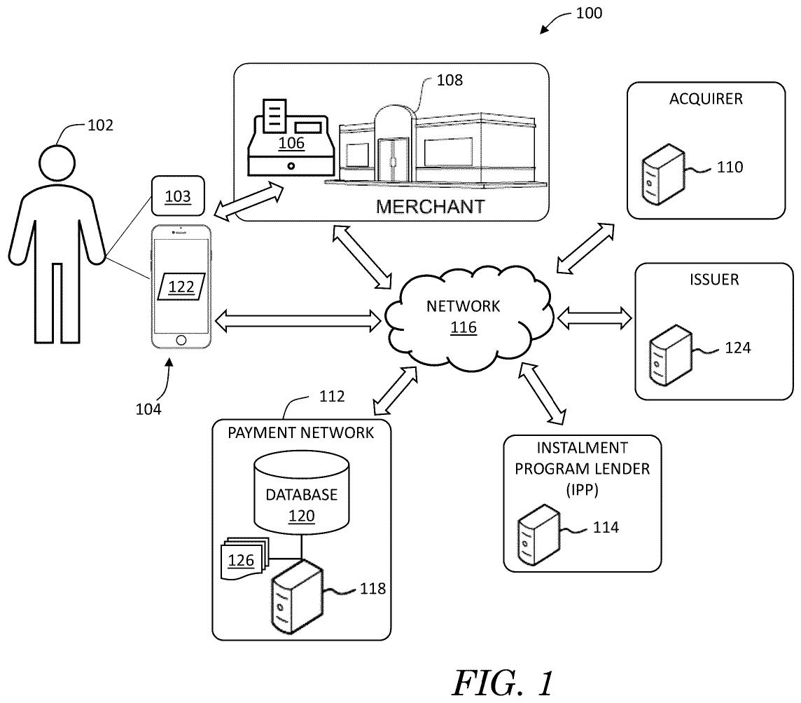

FIG. 1 is a block diagram of an exemplary system 100 for recommending one or more Buy Now, Pay Later (BNPL) financing products (e.g., BNPL loans) to a consumer 102, in accordance with an aspect of the present invention. In the example, the consumer 102 may have access to consumer computing device 104 through which the consumer 102 may request BNPL financing for a purchase transaction made by the consumer 102.

In the example embodiment, the BNPL offer recommendation system 100 may also generally include a merchant 108 having a merchant computer 106 (e.g., a point-of-sale (POS) device or other computing system), a merchant acquirer and its associated computer 110 (the reference character 110 may be used herein in association with the acquirer and/or the acquirer computer), a payment network 112, an installment program provider (IPP) and its associated computer 114 (the reference character 114 may be used herein in association with the IPP and/or the IPP computer), and an issuer and its associated computer 124 (the reference character 124 may be used herein in association with the issuer and/or the issuer computer).

The merchant computer 106 may be a data processing device associated with a merchant, such as the merchant 108. In some embodiments, the merchant computer may include a merchant checkout user interface (UI) displayed on a display of the consumer computing device 104 or other data processing device.

The merchant computer 106, the merchant acquirer computer 110, the payment network 112, the IPP computer 114, and the issuer 124 may be coupled in communication via a communications network 116. The network 116 may include, for example and without limitation, one or more of a local area network (LAN), a wide area network (WAN) (e.g., the Internet, etc.), a mobile network, a virtual network, and/or any other suitable public and/or private network capable of facilitating communication among the merchant computer 106, the acquirer computer 110, the payment network 112, the IPP computer 114, and/or the issuer 124. In some embodiments, the network 116 may include more than one type of network, such as a private payment transaction network provided by the payment network 112 to the acquirer computer 110, the IPP computer 114, and the issuer 124, and, separately, the public Internet, which may facilitate communication between the merchant 108, the payment network computer 112, the acquirer computer 110, the IPP computer 114, the issuer 124, and the consumer 102, etc.

Embodiments described herein may relate to a payment card system, such as a credit card payment system using the Mastercard® interchange network. (Mastercard is a registered trademark of Mastercard International Incorporated). The Mastercard interchange network is a set of proprietary communications standards promulgated by Mastercard for the exchange of financial transaction data and the settlement of funds between financial institutions that are members of the Mastercard interchange network.

In a typical payment card system, a financial institution called the “issuer,” such as the issuer 124, may issue a financial account and an associated payment card, such as a payment card 103, to a consumer, such as the consumer 102. The consumer 102 may use the financial account or payment card 103 to tender payment for a purchase from the merchant 108. Alternatively, the consumer 102 may purchase a good or service from the merchant 108 using a Buy Now, Pay Later loan (BNPL loan) option provided to the consumer 102, for example, at the merchant computer 106 from an IPP 114. The merchant 108 typically may be associated with products, such as goods and/or services, that may be offered for sale and may be sold to the consumer 102. The merchant 108 may include, for example, a physical location and/or a virtual location. A physical location may include, for example, a brick-and-mortar store, etc., and a virtual location may include, for example, an Internet-based storefront.

In the exemplary embodiment, to accept payment with the BNPL loan option, which may be associated with a virtual payment credential, the merchant 108 must normally establish an account with a financial institution that is part of the system 100. This financial institution is usually called the “merchant bank,” the “acquiring bank,” or an “acquirer,” and may operate an acquirer computer 110 (the reference character 110 may be used herein in association with the acquirer and/or the acquirer computer). When the consumer presents payment for a purchase with, for example, the BNPL loan option (e.g., a virtual payment credential issued by the IPP computer 114), the merchant 108 may request authorization from the acquirer computer 110 for the amount of the purchase. Typically, the request is performed using the merchant computer 106.

The merchant computer 106 may communicate electronically with one or more transaction processing computers of the acquirer, such as the acquirer computer 110, to transmit the account information associated with the virtual payment credential thereto. Alternatively, the acquirer may authorize a third party to perform transaction processing on its behalf. In this case, the merchant computer 106 will be configured to communicate with the third party. Such a third party is usually called a “merchant processor,” an “acquiring processor,” or a “third party processor.” In some embodiments, the merchant computer 106 may include a merchant checkout user interface (UI) displayed on the consumer computing device 104 or other data processing device.

Using the payment network 112, computers of the acquirer 110 and/or merchant processor may communicate with computers of the IPP 114 to determine whether the virtual payment credential account is in good standing and whether the purchase is covered by the available credit line. Based on these determinations, the request for authorization may be declined or accepted. If the request is accepted, an authorization code may be issued to the merchant 108.

When a request for authorization is accepted, the available credit line of the virtual payment credential account may be decreased. After the merchant 108 ships or delivers the goods or services, the merchant 108 may capture the transaction by, for example, appropriate data entry procedures on the merchant computer. This may include bundling of approved transactions daily for standard retail purchases. If the consumer(s) cancels the transaction before it is captured, a “void” may be generated. If the consumer(s) returns the goods after the transaction has been captured, a “credit” may be generated. The payment network 112 may store the transaction information, such as, and without limitation, a type of merchant, a merchant identifier, a location where the transaction was completed, an amount of purchase, and a date and time of the transaction, in a transaction database, such as the transaction database 120.

After a purchase has been made, a clearing process may occur to transfer additional transaction data related to the purchase among the parties to the transaction, such as the acquirer computer 110, the payment network 112, and the IPP computer 114. More specifically, during and/or after the clearing process, additional data, such as a time of purchase, a merchant name, a type of merchant, purchase information, user account information, a type of transaction, itinerary information, information regarding the purchased item and/or service, and/or other suitable information, may be associated with a transaction and transmitted between parties to the transaction as transaction data, and may be stored by any of the parties to the transaction.

After a transaction is authorized and cleared, the transaction may be settled among the merchant 108, the acquirer 110, and the IPP 114. Settlement refers to the transfer of financial data or funds among the merchant 108, the acquirer computer 110, and the IPP computer 114 related to the transaction. Usually, transactions may be captured and accumulated into a “batch,” which may be settled as a group. More specifically, a transaction typically may be settled between the IPP computer 114 and the payment network 112, and then between the payment network 112 and the acquirer computer 110, and then between the acquirer computer 110 and the merchant 108.

Normally, an interchange fee may be paid by the acquirer to the issuer (such as the IPP) with respect to a particular transaction. These fees are typically expressed as a percentage of the transaction value, plus a flat fee per transaction. The purpose of the interchange fee is to compensate the issuer for a portion of the risks and costs it incurs. For example, the interchange fee helps to cover the costs associated with processing the transaction, such as fraud prevention and data processing.

In the example, the payment network 112 includes a recommendation system 118. The recommendation system 118 may be configured to receive transaction data, financial account information, personal information, and/or location data from a consumer, such as the consumer 102. The transaction data may include, for example, a large sample of initial and/or historical transaction data with known characteristics or features (i.e., labels). The financial account information may include a bank identification number (BIN) associated with the consumer's financial account or payment card 103. The BIN may allow the recommendation system 118 to identify BNPL offers offered by BNPL providers (such as the IPP 114) and/or merchants (such as the merchant 108) that may be associated with a specific BIN or BIN range. The personal information may include, for example, contact information (e.g., phone number, email address, etc.), demographic information (e.g., age, gender, marital status, income, education, employment, etc.), and the like. Additionally, the location information may include location data identifying a physical or geographic location of the consumer computing device 104, which may generally be associated with the consumer 102.

The recommendation system 118 may also be configured to derive, from the transaction data, purchase preferences and/or lending preferences of a consumer, such as the consumer 102. The purchase preferences may include, for example, the types of products or services the consumer typically purchases (e.g., electronics, clothing, entertainment, etc.). The lending preferences may include, for example, one or more consumer preferred IPPs and/or loan preferences (e.g., loan length, APR, etc.). Loan preferences may include, for example, a loan length, an APR, etc.

The recommendation system 118 may also be configured to receive product data and BNPL loan offers from IPPs, such as the IPP 114. For example, a BNPL loan offer or program may include a credit amount, a credit limit or value, an associated duration or installment period, an annual percentage rate (APR), a product SKU (shop-keeping unit) or SKUs associated with the BNPL loan offer, a date range specifying when the BNPL loan offer is valid, payment card BIN or BIN ranges, restrictions, and the like.

The recommendation system 118 may also be configured to receive product data and available BNPL offers from merchants, such as the merchant 108. For example, the merchant 108 may provide a product SKU or SKUs associated with any BNPL loan offers that the merchant 108 may offer to its customers, such as the consumer 102. For example, the merchant 108 may have a working relationship with one or more IPPs, such as the IPP 114, and may select to offer one or more BNPL loans from the IPP 114 to its customers.

### Exemplary Computer Systems

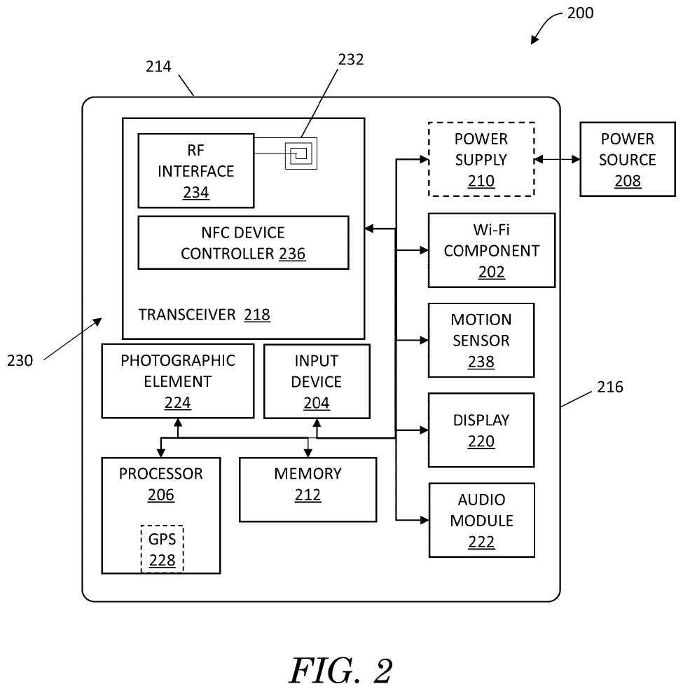

FIG. 2 is an example configuration of a user computing system 200, such as the consumer computing device 104 (shown in FIG. 1) that may be operated by a user, such as the consumer 102 (shown in FIG. 1). In the exemplary embodiment, the computing system 200 may be a computing device configured to connect wirelessly to one or more of the merchant 108, the IPP 114, the network 116, and any other computing devices associated with the system 100.

In the exemplary embodiment, the computing system 200 may generally include a processor 206, a memory device 212, a transceiver 218 (or a wireless communication device), and a photographic element 224. In addition, the computing system 200 may include an integrated Wi-Fi component 202 (e.g., implementing the Institute of Electrical and Electronics/IEEE 802.11 family of standards), an input device 204, a display 220, and an audio module 222. Moreover, the computing system 200 optionally may include an internal power supply 210 (e.g., a battery or other self-contained power source) to receive power, or alternatively, in some embodiments, the computing system 200 may include an external power source 208. Optionally, the computing system 200 may include a motion sensor 238.

The processor 206 may include one or more processing units (e.g., in a multi-core configuration) specially programmed for executing computer readable instructions. The instructions may be executed within a variety of different operating systems (OS) on the computing system 200, such as UNIX, LINUX, Microsoft Windows®, etc. More specifically, the instructions may cause various data manipulations on data stored in the memory device 212 (e.g., create, read, write, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). The memory device 212 may be any device allowing information such as payment card data, the executable instructions, and/or other data to be stored and retrieved. The memory device 212 may include one or more computer readable media.

In the example embodiment, the processor 206 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the computing system 200 may be widely deployed, it may be impractical to manually update software for each computing system 200. Therefore, the system 100 may provide a mechanism for automatically updating the software on the computing system 200. For example, an updating mechanism may be used to automatically update any number of components and their drivers, both network and non-network components, including system level (OS) software components. In some embodiments, the components of the computing system 200 may be dynamically loadable and unloadable; thus, they may be replaced in operation without having to reboot the OS.

A location of the computing system 200 may be obtained through conventional methods, such as a location service (e.g., global positioning system (GPS) service) in the computing system 200, “ping” data that includes geotemporal data, from cell location register information held by a telecommunications provider to which the computing system 200 may be connected, and the like. For example, in one suitable embodiment, a GPS chip 228 may be part of or separate from the processor 206 to enable the location (or geolocation) of the computing system 200 to be determined.

The Wi-Fi component 202 (broadly, a communication interface) may be communicatively connectable to a remote device such as the merchant computer 106 and the network 116. The Wi-Fi component 202 may include, for example, a wireless or wired network adapter or a wireless data transceiver for use with Wi-Fi (e.g., implementing the Institute of Electrical and Electronics/IEEE 802.11 family of standards), Bluetooth communication, radio frequency (RF) communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 212 may be, for example, computer readable instructions for providing a user interface to the user, such as the consumer 102, via the display 220 and, optionally, receiving and processing input from the input device 204. A user interface may include, among other possibilities, a web browser, a client application, a digital wallet, and the like. Web browsers may enable users, such as the consumer 102, to view and interact with media and other information typically embedded on a web page or a website. A client application, such as a BNPL offer recommender service application 122 (shown in FIG. 1), may allow the consumer 102, to interact with a server application, for example, associated with the recommendation system 118 and/or any other computing system associated with the system 100. A digital wallet may allow the consumer 102, to receive, generate, and/or store payment credentials, such as tokens associated with the payment card 103 and/or the virtual payment credential.

The photographic element 224 may include a camera or other optical sensor and lens combination capable of generating a video signal and capturing an image, iris scan, and the like. In various embodiments, the photographic element 224 may be integrated in a housing or body, such as a housing 214, of the computing system 200. When the photographic element 224 captures an image or otherwise generates image data (e.g., video data), the photographic element 224 may store the image data in a data file, either in a raw or compressed format, in the memory device 212.

In some embodiments, the motion sensor 238 may include one or more sensor elements that facilitate detecting a person's presence. For example, the motion sensor 238 may detect when the consumer 102 moves or raises the user consumer system 200. Upon detection of such motion, the photographic element 224 may begin capturing images (e.g., still or video images), the transceiver 218 may be activated, and/or the audio module 222 may begin capturing audio. The motion sensor 238 may be operatively coupled to the photographic element 224 such that the consumer's presence may be detected by detecting motion using the photographic element 224. The motion sensor 238 may include, for example, and without limitation, sensor elements such as a passive infrared sensor, an ambient light sensor, and the like.

In the example embodiment, the display 220 may include, for example, and without limitation, a liquid crystal display (LCD), an organic light emitting diode (OLED) display, or an “electronic ink” display. In some embodiments, a single component such as a touch screen may function as both an output device (e.g., the display 220) and the input device 204. As such, the display 220 may optionally include a touch controller for support of touch capability. In such embodiments, the computing system 200 may detect the presence of the consumer 102, for example, by detecting that the consumer 102 has touched the display 220 of the computing system 200.

The audio module 222 may include, for example, and without limitation, a speaker and related components capable of broadcasting streaming and/or recorded audio and may also include a microphone. The microphone facilitates capturing audio through the computing system 200.

In the example embodiment, the computing system 200 includes the housing 214 at least partly (and more preferably, at least substantially or entirely) enclosing the components described above. In addition, the computing system 200 includes circuitry 230 configured to communicate with the network 116 (shown in FIG. 1) and/or other computing devices (e.g., other mobile devices, the computers or systems 106, 110, 112, 114, 118, and 124, etc.). The circuitry 230 may include, for example, leads, connectors, NFC-enabled circuitry, Wi-Fi-enabled circuitry, and photographic element circuitry. The housing 214 is preferably configured to seal the circuitry 230, which is susceptible to degradation from the ambient environment. In one embodiment, the circuitry 230 is hermetically sealed in the housing 214. For example, in one embodiment, the circuitry 230 is completely and permanently encased within the housing 214. In other words, the housing 214 and the circuitry 230 are intended to remain as a single, inseparable unit throughout the life of the computing system 200. It is understood that the housing 214 can be formed separately from the circuitry 230 and that the circuitry 230 can be placed into and sealed within the housing 214 in a separate operation. It is also understood that the housing 214 can be oversized with respect to the circuitry 230 so that the circuitry 230 can be placed loosely into the housing 214. In another embodiment, the circuitry 230 can be selectively, sealingly enclosed within the housing 214, where the housing 214 includes a closure 216 removably attached to a body of the housing 214.

The housing 214 may be fabricated from a suitably selected material that facilitates inhibiting the effect the material has on the signal being emitted from, for example, the transceiver 218 and/or the Wi-Fi component 202 and passing through the housing material. For example, and without limitation, suitable materials from which the housing 214 may be fabricated include polyethylene, propylene, isoprene, and butylenes (i.e., polyolefins). In other embodiments, the housing 214 may be fabricated from any material that enables the computing system 200 to function as described herein, such as metals, etc.

In one embodiment, the transceiver 218 may include an antenna 232. The antenna 232 includes a looped wire configured to transmit radio signals when current flows through the looped wire. The antenna 232 is any size, shape, and configuration that is suitable for transmitting signals as described herein. For example, the antenna 232 may be a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 232 generates a magnetic field when it vibrates at a selected frequency. Specifically, the antenna 232 may be configured to vibrate at a frequency of about 13.56 MHz, which is suitable for use in a near field communication (NFC) system.

In the example embodiment, the antenna 232 may transmit radio signals to and may receive radio signals from other wireless-enabled computing devices, for example, another mobile device, the computers or systems 106, 110, 112, 114, 118, and 124, and/or any other components used in wireless systems. In NFC systems, for example, at least one NFC component generates a magnetic field to inductively transfer currents and, thereby, exchange signals and information with other NFC components positioned within the magnetic field. In one example embodiment, the antenna 232 may function as an NFC component to send and receive signals. The antenna 232 may be configured to transmit radio signals to NFC components positioned within the magnetic field of the antenna 232, such as when the computing system 200 is positioned within a predetermined distance of the merchant computer 106. Therefore, the magnetic field generated by the antenna 232 may define the active range of the computing system 200. Additionally, the antenna 232 may receive radio signals from NFC components when the antenna 232 is positioned within the magnetic field of the NFC components.

The transceiver 218 also may include a radio frequency (RF) interface 234 and an NFC device controller 236. The RF interface 234 and the NFC device controller 236 may be powered by the power source 208, and in some embodiments, the internal power supply 210 and/or the display 220. In addition, the processor 206 and the memory device 212 may be powered in the same manner. The RF interface 234 may be configured to receive and transmit RF signals through the antenna 232. The NFC device controller 236 may be configured to process the received RF signals and to generate signals to be transmitted by the RF interface 234. The memory device 212 may be configured to store data associated with transmitting and receiving the RF signals. The NFC device controller 236 may be coupled in communication with the processor 206.

In some embodiments, the computing system 200 may be connected to one or more peripheral devices (not shown). That is, the computing system 200 may communicate various data with one or more peripheral devices. For example, the computing system 200 may communicate with one or more peripheral devices through the Wi-Fi component 202, the transceiver 218, or other suitable means.

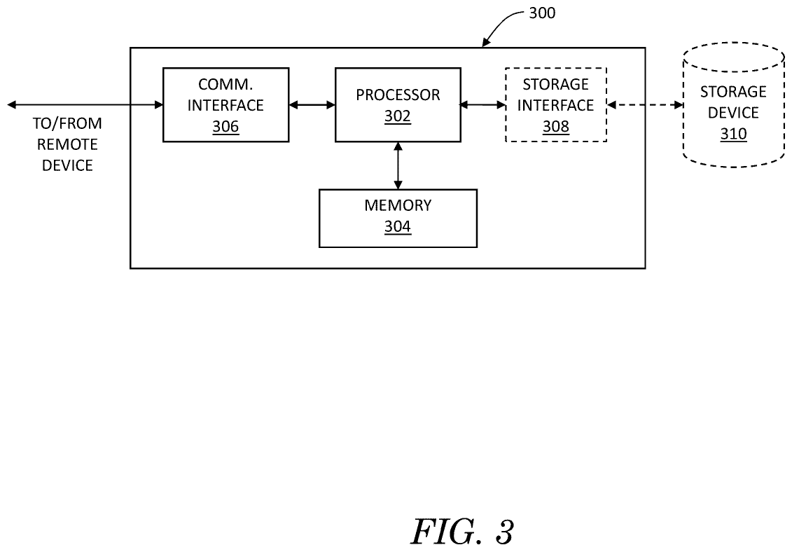

FIG. 3 is an example configuration of a server system 300. In an embodiment, the server system 300 may include, but not be limited to, the merchant computer 106, the acquirer computer 110, the IPP computer 114, and/or the issuer computer 124 (all shown in FIG. 1). In the example embodiment, the server system 300 may include a processor 302 for executing instructions. The instructions may be stored in a memory 304, for example. The processor 302 may include one or more processing units (e.g., in a multi-core configuration) for executing the instructions. The instructions may be executed within a variety of different operating systems on the server system 300, such as UNIX, LINUX, Microsoft Windows®, etc. More specifically, the instructions may cause various data manipulations on data stored in a storage device 310 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 302 may be operatively coupled to a communication interface 306 such that the server system 300 can communicate with a remote device such as a user computing system 200 (shown in FIG. 2), one or more of the computers or systems 104, 106, 110, 112, 114, 118, and 124, and/or another server system. For example, the communication interface 306 may receive communications from a consumer computing device 104 via the Internet (FIG. 1).

The processor 302 may be operatively coupled to the storage device 310. The storage device 310 may be any computer-operated hardware suitable for storing and/or retrieving data. In some embodiments, the storage device 310 may be integrated in the server system 300. In other embodiments, the storage device 310 may be external to the server system 300. The storage device may be similar to the database 120 (shown in FIG. 1). For example, the server system 300 may include one or more hard disk drives as the storage device 310. In other embodiments, the storage device 310 may be external to the server system 300 and may be accessed by a plurality of server systems 300. For example, the storage device 310 may include multiple storage units such as hard disks or solid-state disks in a redundant array of inexpensive disks (RAID) configuration. The storage device 310 may include a storage area network (SAN) and/or a network attached storage (NAS) system.

In some embodiments, the processor 302 may be operatively coupled to the storage device 310 via a storage interface 308. The storage interface 308 may be any component capable of providing the processor 302 with access to the storage device 310. The storage interface 308 may include, for example, an Advanced Technology Attachment adapter, a RAID controller, a SAN adapter, a network adapter, and/or any component providing the processor 302 with access to the storage device 310.

The memory 304 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

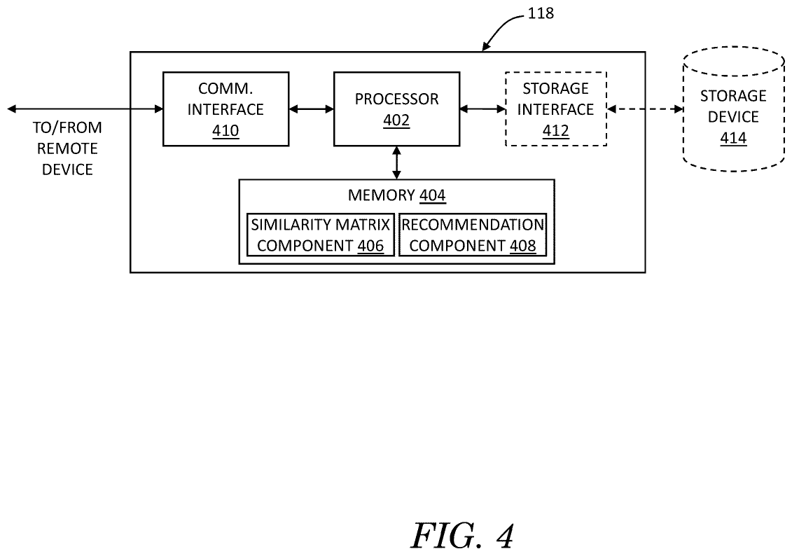

FIG. 4 is an example configuration of the recommendation system 118. In the example embodiment, the recommendation system 118 may include a processor 402 for executing instructions. The instructions may be stored in a memory 404, for example. In an embodiment, one or more processes executed by the recommendation system 118 may be implemented in the form of programming instructions of one or more software modules, components, or engines, such as a similarity matrix component 406 and a recommendation component 408, stored on the memory 404. However, it will be apparent that the processes could alternatively be implemented, either in part or in their entirety, in the form of one or more dedicated hardware components, such as application-specific integrated circuits (ASICs), and/or in the form of configuration data for configurable hardware components, such as field programmable gate arrays (FPGAs), for example.

In the example, the processor 402 may include one or more processing units (e.g., in a multi-core configuration) for executing the instructions. The instructions may be executed within a variety of different operating systems on the recommendation system 118, such as UNIX, LINUX, Microsoft Windows®, etc. More specifically, the instructions may cause various data manipulations on data stored in a storage device 414 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 may be operatively coupled to a communication interface 410 such that the recommendation system 118 can communicate with a remote device such as a user computing system 200 (shown in FIG. 2), one or more of the computers or systems 104, 106, 110, 112, 114, and 124, and/or another server system. For example, the communication interface 410 may receive communications from a consumer computing device 104 via the Internet (FIG. 1) and/or one or more merchant computers 106 via the network 116.

The processor 402 may be operatively coupled to the storage device 414. The storage device 414 may be any computer-operated hardware suitable for storing and/or retrieving data. In some embodiments, the storage device 414 may be integrated in the recommendation system 118. In other embodiments, the storage device 414 may be external to the recommendation system 118. The storage device may be similar to the database 120 (shown in FIG. 1). For example, the recommendation system 118 may include one or more hard disk drives as the storage device 414. In other embodiments, the storage device 414 may be external to the recommendation system 118 and may be accessed by a plurality of server systems 300 and/or recommendation systems 118. For example, the storage device 414 may include multiple storage units such as hard disks or solid-state disks in a redundant array of inexpensive disks (RAID) configuration. The storage device 414 may include a storage area network (SAN) and/or a network attached storage (NAS) system.

In some embodiments, the processor 402 may be operatively coupled to the storage device 414 via a storage interface 412. The storage interface 412 may be any component capable of providing the processor 402 with access to the storage device 414. The storage interface 412 may include, for example, an Advanced Technology Attachment adapter, a RAID controller, a SAN adapter, a network adapter, and/or any component providing the processor 402 with access to the storage device 414.

The memory 404 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

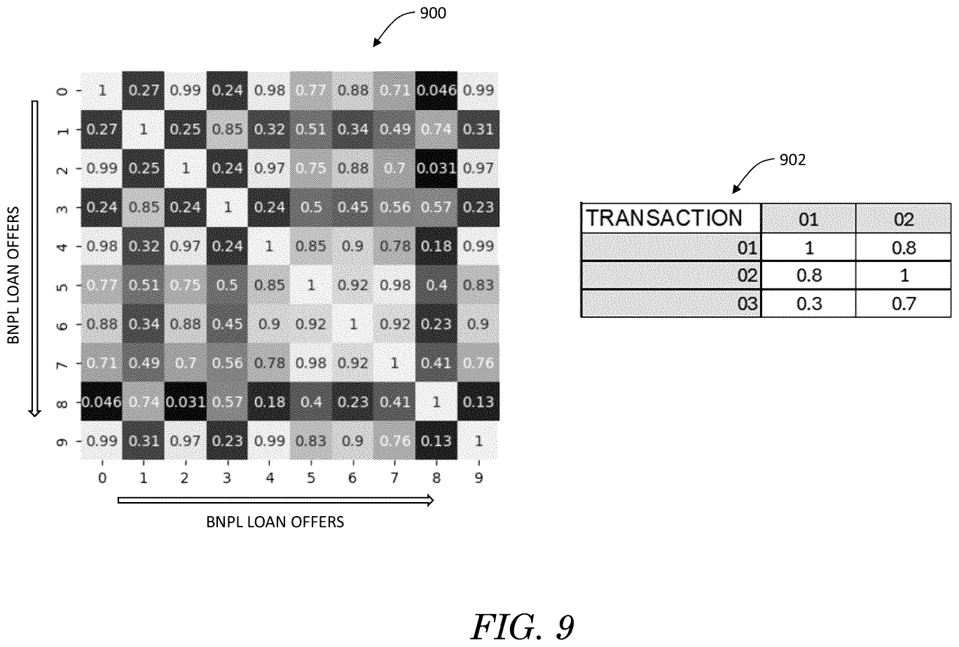

In an embodiment, the similarity matrix component 406 may retrieve transaction data from the transaction database 120 (shown in FIG. 1). Furthermore, the similarity matrix component 406 may analyze the transaction data to determine a similarity between consumers and/or BNPL loan offers. The similarity matrix component 406 may generate a BNPL loan offer similarity matrix 900 (See FIG. 9) and a transaction similarity matrix 902. The recommendation component 408 (also referred to as a recommendation engine or model) may use the similarity matrices 900, 902 to recommend to the consumer 102, at the consumer computing device 104, one or more BNPL loan offers that might be suitable for a selected purchase transaction. While the similarity matrix component 406 and the recommendation component 408 are depicted as being executed on a single computing system, such as the recommendation system 118 shown in FIG. 4, it should be appreciated that in some embodiments, the recommendation system 118 may include a first computing device configured to execute the similarity matrix component 406 and a second computing device configured to execute the recommendation component 408.

### Computer-Implemented Methods

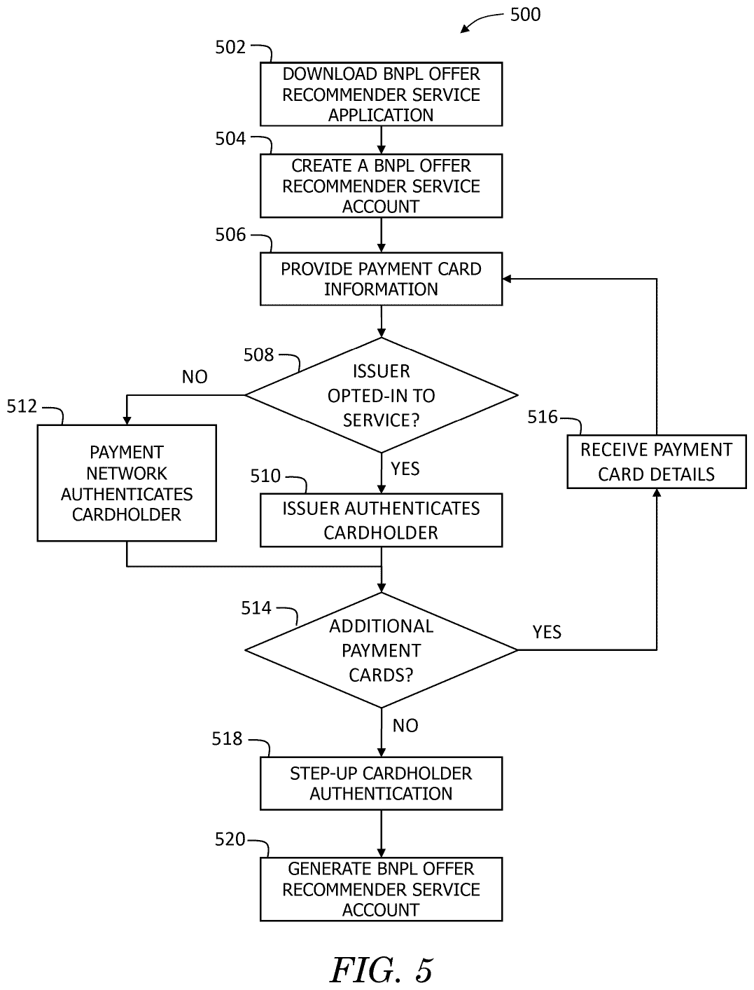

FIG. 5 is a flowchart illustrating an exemplary computer-implemented method 500 for registering a consumer, such as the consumer 102, for a Buy Now, Pay Later (BNPL) offer recommender service, in accordance with embodiments of the present disclosure. The operations described herein may be performed in the order shown in FIG. 5 or may be performed in a different order. Furthermore, some operations may be performed concurrently as opposed to sequentially. In addition, some operations may be optional.

The computer-implemented method 500 is described below, for ease of reference, as being executed by exemplary devices and components introduced with the embodiments illustrated in FIGS. 1-4. In one embodiment, the method 500 may be implemented by the payment network 112 (shown in FIG. 1). In the exemplary embodiment, the method 500 generally concerns the receipt of consumer registration information from the consumer computing device 104 (shown in FIG. 1) upon registration for the BNPL offer recommender service. While operations within the method 500 are described below regarding the consumer computing device 104, the method 500 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

Referring to operation 502, in the example embodiment, the consumer 102 may download the BNPL offer recommender service application 122 (shown in FIG. 1). For example, the consumer 102 may connect to the payment network 112, which may instruct the consumer 102 to download the BNPL offer recommender service application 122 to the consumer computing device 104 for direct communication with the recommendation system 118 via the payment network 112, e.g., without use of a web browser. When the consumer 102 uses the BNPL offer recommender service application 122, a direct link may be established via a wireless connection, for example, via a Wi-Fi connection to the network 116. The consumer computing device 104, such as a web-based smartphone, may be configured to execute for display the BNPL offer recommender service application 122. In some embodiments, the BNPL offer recommender service application 122 may be stored in a cloud-based interface, which may include cloud storage capability as well as any cloud-based API that facilitates communication between the consumer computing device 104 and recommendation system 118. The BNPL offer recommender service application 122 may facilitate transmitting and receiving data between the consumer computing device 104 and the payment network 112 to enroll the consumer 102 and identify/notify the consumer 102 of one or more recommended BNPL loan offers available to the consumer 102 for a transaction, as described further herein.

At operation 504, the consumer 102 may be presented with an option to create a BNPL offer recommender service account. For example, the consumer 102 may enroll for the BNPL offer recommender service via the BNPL offer recommender service application 122 or via a suitable webpage of the payment network 112 using, for example, the consumer computer system 104. The consumer 102 may enroll or register with the BNPL offer recommender service in any of several ways, including utilizing the consumer computer system 104 to access the payment network 112 via the Internet and providing required information. During consumer enrollment, the consumer 102 may provide enrollment data including basic information about himself or herself (e.g., name, address, phone number, email address, etc.) and, in some embodiments, provide information regarding the customer's computing devices (for example, by providing a SIM identifier, a mobile telephone number, and/or other device identifier).

It is noted that the BNPL offer recommender service account may be linked to other Mastercard services, such as if the consumer 102 is already signed up for one or more other Mastercard services. In some embodiments, the information obtained from the consumer 102 during the enrollment process may include product and/or service preferences, and/or other information.

At operation 506, the consumer 102 may also provide information concerning his or her payment card 103, e.g., a bank credit card account, a debit card account, and/or a prepaid card issued to or held by him or her, including the bank identification number (BIN) associated with the consumer's financial account or payment card 103.

At operation 508, the payment network 112 may determine whether the issuer 124 of the payment card 103 has opted-in to the BNPL offer recommender service. If the issuer 124 has chosen to opt-in to the BNPL offer recommender service, at operation 510 the issuer 124 may authenticate the consumer 102 in real-time. For example, and without limitation, the issuer 124 may authenticate the consumer 102 via a one-time code sent to the consumer 102 via Short Message Service (SMS), e-mail, through an issuer mobile application, through a call center communication, and the like. In the exemplary embodiment, issuer authentication may be the preferred method for authenticating the consumer 102, as the issuer 124 and the consumer 102 have a direct relationship.

If the issuer 124 has not chosen to opt-in to the BNPL offer recommender service and therefore does not participate in the enrollment process, at operation 512, the payment network 112 may authenticate the consumer 102. Optionally, in an embodiment, the method 500 may include an operation for authenticating the consumer 102 offline. For example, and without limitation, the payment network 112 may provide an offline PIN to the consumer 102 via mail. While this method allows the consumer 102 to be authenticated, it may not be as strong of an authentication or verification as provided by the issuer 124.

At operation 514, the payment network 112 may ask the consumer 102 whether the consumer has additional payment cards he or she wishes to associate with the consumer's BNPL offer recommender service account. If the consumer has additional payment cards to enter, at operation 516, the payment network 112 may receive the payment card details from the consumer 102 and return to operation 506. If the consumer does not have any additional payment cards to enter, the method may continue to operation 518.

At operation 518, the payment network 112 may request that the consumer 102 set up a step-up authentication method, i.e., two-factor authentication. The additional authentication measures may be taken before a transaction may be entered into the BNPL offer recommender service. For example, and without limitation, in one embodiment, the consumer 102 may be requested to establish account access credentials, e.g., to select a username and password or PIN (personal identification number) to be used for security purposes, and/or for use by the consumer 102 to login and change one or more preference and/or requirement settings. In addition to the password or PIN, the consumer 102 may be requested to set up a second authentication factor, including, for example, and without limitation, providing a biometric sample that is to be associated with the other registration information provided.

Biometric samples may include, without limitation, a fingerprint image, a voice recording, a retinal image, facial recognition, palm print image, iris recognition, and the like. The biometric sample may be unique to the consumer 102 and difficult to duplicate and/or forge by an unauthorized user. The biometric sample may be stored and associated with a biometric identifier, for example, by the payment network 112 (e.g., in the database 120). Additionally, the biometric identifier may be associated with the stored registration information and may facilitate secure authorization of information input by the consumer 102. A biometric input device in communication with the consumer computing device 104 may be used for the consumer 102 to enter the biometric sample. For example, the consumer computing device 104 may include an integral fingerprint or palm reader/scanner, retinal or iris reader/scanner, and/or voice reader/recorder.

In other suitable embodiments, the second factor may include, for example, and without limitation, SMS two-factor authentication (where a one-time use short code in sent to the consumer's mobile device via SMS), Time-Based One Time Password (TOTP) authentication (where an authenticator application provides a short code as a second factor), push-based two-factor authentication (where a prompt is sent to the consumer's mobile device), or any other two-factor authentication method that enables the method 500 to operate as described herein.

At operation 520, the payment network 112 may generate the BNPL offer recommender service account or profile for the consumer 102, associating the consumer's payment card 103 (and any additionally added payment cards) with the consumer's profile, along with the consumer's account access credentials.

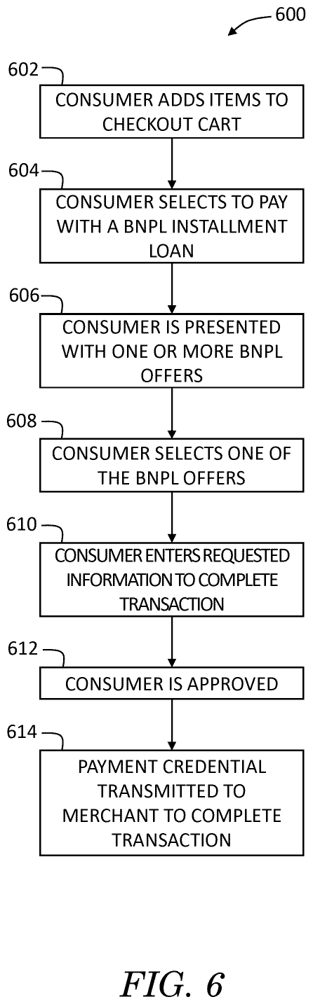

FIG. 6 is a flowchart illustrating an exemplary computer-implemented method 600 for completing a transaction with a recommended Buy Now, Pay Later (BNPL) offer made available to a consumer, such as the consumer 102, in accordance with embodiments of the present disclosure. The operations described herein may be performed in the order shown in FIG. 6 or may be performed in a different order. Furthermore, some operations may be performed concurrently as opposed to sequentially. In addition, some operations may be optional.

The computer-implemented method 600 is described below, for ease of reference, as being executed by exemplary devices and components introduced with the embodiments illustrated in FIGS. 1-4. In one embodiment, the method 600 may be implemented by the payment network 112 (shown in FIG. 1), and more particularly, by the recommendation system 118. In the exemplary embodiment, the method 600 executes a transaction of a consumer using a selected, relevant BNPL loan offer that is available to a consumer. While operations within the method 600 are described below regarding the recommendation system 118, the method 600 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

In the exemplary embodiment, at operation 602, the consumer 102 selects one or more items to purchase from a merchant, such as the merchant 108 (shown in FIG. 1), and adds it to his or her checkout cart on the merchant's website. Alternatively, the consumer 102 may select one or more items for purchase from a merchant storefront and present the items for checkout at the merchant computer 106 (e.g., a merchant POS). During checkout, the consumer 102 is presented with several payment options, including an option to use a BNPL loan.

At operation 604, the consumer 102 selects to pay the transaction using a BNPL loan. Upon selection of the option to pay with a BNPL loan, the consumer 102 may be requested to provide his or her account access credentials to his or her BNPL offer recommender service account or profile. If the consumer does not have a BNPL offer recommender service account or profile, he or she may be requested to register for one to avail himself or herself to the BNPL offer recommender service features (see the method 500 shown in FIG. 5). After the consumer logs into his or her account with the account access credentials, the recommendation system 118 receives the transaction data, which may include product specific data. The product specific data may include, for example, stock keeping unit (SKU) data, from the merchant, such as the merchant 108 (shown in FIG. 1). In some embodiments, the recommendation system 118 may receive an alternative product/goods identifier other than SKU data. Moreover, the recommendation system 118 may receive product specific data from the merchant computer 106, such as by QR/barcode scanning, inventory managements systems, etc. The product specific data may additionally include, without limitation, image and/or text data, an item category, one or more characteristics or attributes, and the like. For example, an item category may include food and beverage, clothing, electronics, apparel, sporting goods, books, media type, or other methods of describing a product. The one or more characteristics or attributes may include, for example, tangible and intangible characteristics or attributes. Tangible product attributes may include physical characteristics such as size, weight, and color, whereas intangible product attributes may include non-physical features such as price, quality, aesthetics, etc.

Based on the transaction data and the consumer data associated with the consumer's BNPL offer recommender service account or profile, at operation 606, the recommendation system 118 presents one or more recommended BNPL loan offers 126 (i.e., a personalized list of BNPL loan offers) (see FIG. 1) to the consumer 102, for example, via the merchant computer 106 and/or the consumer computing device 104.

At operation 608, the consumer 102 selects one of the presented recommended BNPL loan offers 126. Upon the selection, at operation 610, the consumer 102 is requested to input various information required by the installment program provider (IPP) 114. The information may include, for example, personal information (e.g., name, address, phone number, government identifier, etc.), demographic information (e.g., age, income, education, employment, etc.), and the like. Some of the requested information may be automatically input or otherwise provided based on the BNPL offer recommender service account or profile for the consumer 102.

At operation 612, the IPP 114 may approve the consumer for the selected BNPL loan. Upon approval, the IPP 114 transmits a payment credential to the merchant 108 or merchant computer 106 for completion of the transaction. The payment credential is associated with the BNPL loan.

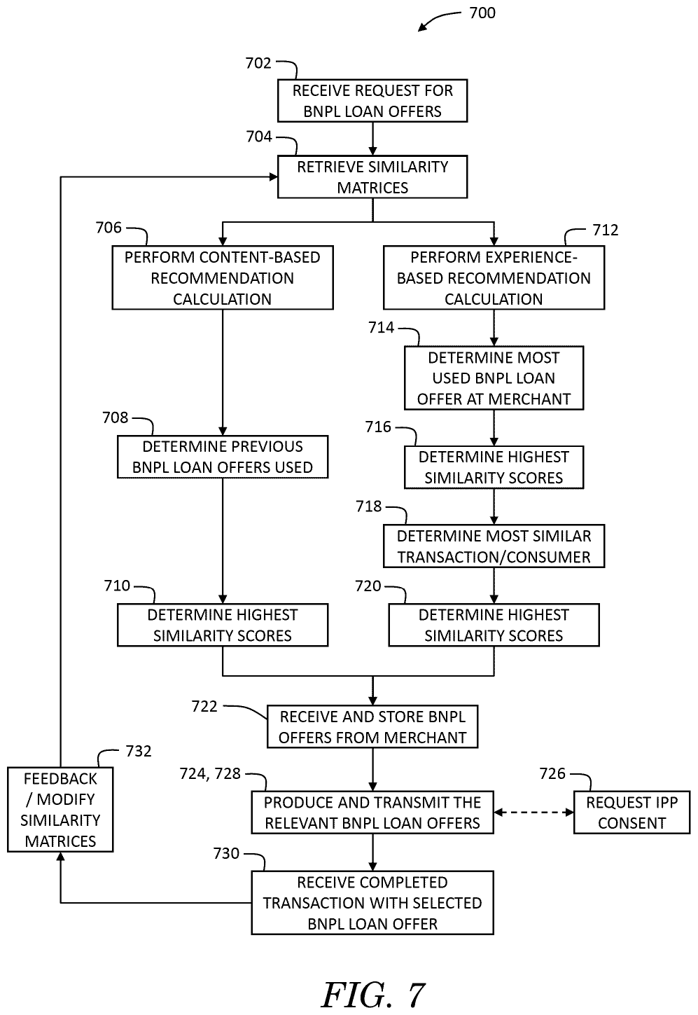

FIG. 7 is a flowchart illustrating an exemplary computer-implemented method 700 for recommending the one or more recommended BNPL loan offers 126 discussed above at operation 606 of the method 600, in accordance with embodiments of the present disclosure. The operations described herein may be performed in the order shown in FIG. 7 or may be performed in a different order. Furthermore, some operations may be performed concurrently as opposed to sequentially. In addition, some operations may be optional.

The computer-implemented method 700 is described below, for ease of reference, as being executed by exemplary devices and components introduced with the embodiments illustrated in FIGS. 1-4. In one embodiment, the method 700 may be implemented by the payment network 112 (shown in FIG. 1), and more particularly, by the recommendation system 118. In the exemplary embodiment, the method 700 identifies the recommended BNPL loan offers 126 that are available to a consumer, such as the consumer 102, based on the consumer's transaction data, historical transactions, purchase preferences, lending preferences, personal information, and/or location data. While operations within the method 700 are described below regarding the recommendation system 118, the method 700 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

At operation 702, the recommendation system 118 receives a request for a personalized list of BNPL loan offers, such as the recommended BNPL loan offers 126, for a transaction being performed by a consumer, such as the consumer 102. The request may be received from the merchant computer 106 (e.g., directly from the merchant computer 106 or from the acquirer 110). In instances where the consumer computing device 104 is operating as a point-of-sale device, the request may be received from the consumer computing device 104. The request may include, for example, transaction data associated with the transaction. The transaction data may include, for example, a transaction amount, a date and time of the transaction, merchant data (e.g., merchant category code (MCC), location, etc.), product specific data, and the like. The product specific data may include, for example, stock keeping unit (SKU) data from the merchant, such as the merchant 108 (shown in FIG. 1), image and/or text data, an item category, one or more characteristics or attributes, and the like. The request may also include consumer account access credentials for the consumer's BNPL offer recommender service account or profile.

At operation 704, the recommendation system 118 retrieves from the database 120 (shown in FIG. 1) one or more similarity matrices, such as the BNPL loan offer similarity matrix 900 and the transaction similarity matrix 902. The transaction data and the similarity matrices 900, 902 are then used by the recommendation component 408 (or recommendation engine or model) to determine a recommendation score for each offer, as discussed below. The recommendation scores can then be used to generate a ranked list of offers, with the highest ranked offers (e.g., top five (5) or ten (10) offers) defining the recommended BNPL loan offers 126. In some embodiments, instead of a list of the highest ranked offers being recommended, the recommendation component 408 may recommend all BNPL loan offers having a recommendation score which is equal to or greater than some threshold value.

At operation 706, the recommendation component 408 performs a content-based recommendation calculation. The content-based recommendations work under the assumption that the consumer 102 is an existing user of the BNPL offer recommender service and has used one or more BNPL loan offers to complete previous transactions. Thus, the consumer 102 has historical transaction records available to the BNPL offer recommender service. The historical transaction records include only those transactions performed by the consumer 102 using a BNPL loan offer.

To perform the content-based recommendation calculation, at operation 708, the recommendation component 408 retrieves and determines, from the consumer's historical transaction records, the previous BNPL loan offers used by the consumer 102 and the number of times each previously used BNPL loan offer was selected for use by the consumer.

Additionally, at operation 710, the recommendation component 408 determines, for each of the previous BNPL loan offers used by the consumer 102, the highest similarity scores (e.g., top five (5) or ten (10) similarity scores) associated with other offers in the BNPL loan offer similarity matrix 900. For example, the recommendation component 408 may determine each similarity score for each of the previous BNPL loan offers used by the consumer and each of the other offers in the BNPL loan offer similarity matrix 900. The recommendation component 408 may then rank all similarity scores (and their associated BNPL loan offers) from highest similarity score to lowest similarity score, and select the highest similarity scores. The recommendation component 408 may then generate a ranked list of the similar offers, for example, based on the previous BNPL loan offers used by the consumer 102, the number of times each was used, and the similarity scores. In some embodiments, the recommendation component 408 may apply a weighting factor to one or more of the previous BNPL loan offers used by the consumer 102, the number of times each was used, and the similarity scores to facilitate generating the ranked list.

At operation 712, the recommendation component 408 performs an experience-based recommendation calculation. The experience-based recommendations work under the assumption that the consumer 102 is a new consumer, i.e., a consumer that is not a registered user of the BNPL offer recommender service and/or has not previously used one or more BNPL loan offers to complete any previous transactions. Thus, the consumer 102 has no historical transaction records available to the BNPL offer recommender service.

To perform the experience-based recommendation calculation, at operation 714, the recommendation component 408 determines the most used BNPL loan offer used at the merchant performing the transaction. For example, the recommendation component 408 may extract the merchant information from the transaction data. Based on historical transaction data stored in the database 120, the recommendation component 408 determines the most used BNPL loan offer for that merchant.

At operation 716, using the most used BNPL loan offer for the merchant, the recommendation component 408 determines, from the BNPL loan offer similarity matrix 900, the highest similarity scores (e.g., top five (5) or ten (10) similarity scores) associated with other offers listed in the BNPL loan offer similarity matrix 900. For example, the recommendation component 408 may determine each similarity score for the most used BNPL loan offer for the merchant and each of the other offers in the BNPL loan offer similarity matrix 900. The recommendation component 408 may then rank all similarity scores (and their associated BNPL loan offers) from highest similarity score to lowest similarity score, and select the highest similarity scores. The recommendation component 408 may then generate a ranked list of the similar offers, for example, based on the similarity scores.

At operation 718, the recommendation component 408 determines the most similar consumer or transaction associated with the BNPL offer recommender service, i.e., another consumer that is registered with the BNPL offer recommender service or a transaction that includes a selection of an offer recommended by the BNPL offer recommender service. For example, the recommendation component 408 generates a feature vector for the transaction data associated with the request for the personalized list of BNPL loan offers. The recommendation component 408 then computes a cosine similarity (i.e., similarity score) between the feature vector for the transaction data and each existing transaction in the transaction similarity matrix 902. This can be done, for example, by taking the dot product of the transaction data feature vector with the feature vectors of each existing transaction and dividing by the product of their magnitudes. The recommendation component 408 may then rank the transactions based on their similarity scores with the new transaction. The highest similarity score indicates the most similar transaction associated with the BNPL offer recommender service.

At operation 720, the recommendation component 408 determines, from the historical transaction records of the consumer associated with the most similar transaction, the previous BNPL loan offers used by the similar consumer and the number of times each previously used BNPL loan offer was selected for use. The recommendation component 408 may then determine, for each of the previous BNPL loan offers used by the similar consumer, the highest similarity scores (e.g., top five (5) or ten (10) similarity scores) associated with other offers in the BNPL loan offer similarity matrix 900. For example, the recommendation component 408 may determine each similarity score for each of the previous BNPL loan offers used by the similar consumer and each of the other offers in the BNPL loan offer similarity matrix 900. The recommendation component 408 may then rank all similarity scores (and their associated BNPL loan offers) from highest similarity score to lowest similarity score, and select the highest similarity scores. The recommendation component 408 may then generate a ranked list of the similar offers, for example, based on the previous BNPL loan offers used by the similar consumer, the number of times each was used, and the similarity scores. In some embodiments, the recommendation component 408 may apply a weighting factor to one or more of the previous BNPL loan offers used by the similar consumer, the number of times each was used, and the similarity scores to facilitate generating the ranked list.

After completion of the calculations, at operation 724, the recommendation component 408 ranks the most recommended BNPL loan offers from the content-based recommendation calculation and the experience-based recommendation calculation. Optionally, the recommendation component 408 may filter the most recommended BNPL loan offers according to the consumer's preferences, such as, purchase preferences, lending preferences, personal information, and/or location data. The purchase preferences may be derived from the historical transaction records and may include, for example, the types of products or services the consumer typically purchases (e.g., electronics, clothing, entertainment, etc.). The lending preferences may be derived from the historical transaction records and may include, for example, one or more consumer preferred IPPs and/or loan preferences (e.g., loan length, APR, etc.). The personal information may include, for example, contact information (e.g., phone number, email address, etc.), demographic information (e.g., age, gender, marital status, income, education, employment, etc.), and the like. Additionally, the location information may include location data identifying a physical or geographic location of the consumer computing device 104, which may generally be associated with the consumer 102. The purchase preferences, lending preferences, personal information, and/or location data may be used by recommendation component 408 to filter the recommended BNPL loan offers.

At operation 724, the recommendation component 408 uses the filtered list to produce the recommended BNPL loan offers 126. The recommended BNPL loan offers 126 may include a mixture of offers from the content-based recommendation calculation and the experience-based recommendation calculation, or offers from only one or the other of the calculations. The recommendation component 408 may apply a threshold or mixing factor to the two (2) calculation results to determine the recommended BNPL loan offers 126. For example, if the consumer 102 is a registered user of the BNPL offer recommender service and has selected multiple offers in the past, the recommendation component 408 may place more weight on the content-based recommendation calculation results. Alternatively, if the consumer is new to the service, the content-based recommendation calculation may place more weight on the experience-based recommendation calculation.

Optionally, at operation 726, the recommendation component 408 may request consent from each IPP associated with the recommended BNPL loan offers 126 to provide the respective offers to the consumer. If one or more IPPs choose not to provide consent or otherwise do not provide consent, the recommendation component 408 may remove that offer from the recommended BNPL loan offers 126 and generate a new set of recommended BNPL loan offers.

At operation 728, the recommendation component 408 transmits the recommended BNPL loan offers 126 to the requesting party, e.g., the merchant computer 106 (e.g., directly to the merchant computer 106 or to the acquirer 110) or, in instances where the consumer computing device 104 is operating as a point-of-sale device, the consumer computing device 104.

At operation 730, upon completion of the transaction using the consumer selected BNPL loan offer, the recommendation system 118 receives notification of the completed transaction and use of the selected BNPL loan offer. The transaction data associated with the transaction may be stored by the recommendation system 118, for example in the database 120, for future use in updating the transaction similarity matrix 902. For example, at operation 732, the transaction data may be fed back to the recommendation component 408. Based on the feedback, the recommendation component 408 may modify the transaction similarity matrix 902 so that the matrix can be refined or modified according to the new transaction and the consumer selected BNPL loan offer.

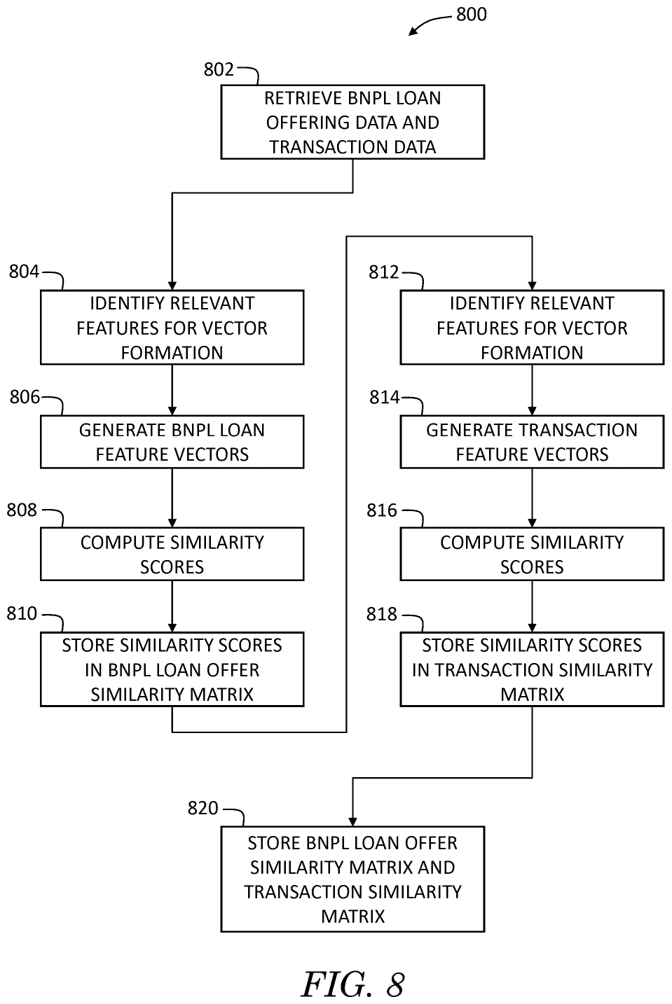

FIG. 8 is a flowchart illustrating an exemplary computer-implemented method 800 for generating at least one similarity matrix, such as the BNPL loan offer similarity matrix 900 and the transaction similarity matrix 902, implemented at least in part by the similarity matrix component 406, in accordance with embodiments of the present disclosure. The operations described herein may be performed in the order shown in FIG. 8 or may be performed in a different order. Furthermore, some operations may be performed concurrently as opposed to sequentially. In addition, some operations may be optional.

The computer-implemented method 800 is described below, for ease of reference, as being executed by exemplary devices and components introduced with the embodiments illustrated in FIGS. 1-4. In one embodiment, the method 800 may be implemented by the payment network 112 (shown in FIG. 1), and more particularly, by the recommendation system 118. In the exemplary embodiment, the method 800 produces similarity matrices representing, for example, similarity between BNPL loan offers or similarity between historical BNPL loan transactions. While operations within the method 800 are described below regarding the recommendation system 118, the method 800 may be implemented on other computing devices and/or systems through the utilization of processors, transceivers, hardware, software, firmware, or combinations thereof. A person having ordinary skill will further appreciate that responsibility for all or some of the actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the operations outlined herein. The program(s) stored on the computer-readable medium(s) may instruct the processor or processing units to perform additional, fewer, or alternative actions, including those discussed elsewhere herein.

At operation 802, the similarity matrix component 406 retrieves, from the database 120 (shown in FIG. 1), BNPL loan offering data representing BNPL loan offers provided by one or more IPPs 114 and historical transaction data representing a plurality of transaction records for transactions that included funding via one of the BNPL loan offers.

At operation 804, the similarity matrix component 406 identifies, from the BNPL loan offering data, various relevant features of the BNPL loan offers to be used for the feature vectors. The features may include, for example, a unique identifier for each BNPL loan offering, associated IPP, an interest rate, installment frequency, dates offer is available, purchase amount requirements, applicable locations and currency, installment schedule, any fees, and the like. The similarity matrix component 406 may convert all the categorical data into respective categorical codes. In addition, the similarity matrix component 406 may convert all string data fields to numerical values. The data may be normalized so that wider range values do not have a higher weighted value as compared to narrower range values.

At operation 806, the similarity matrix component 406 generates feature vectors for each BNPL loan offering. For example, the normalized feature values for each respective BNPL loan offer are stored in a respective BNPL loan offering vector.

At operation 808, the similarity matrix component 406 computes a similarity score between each BNPL loan offering, using the BNPL loan offering vectors. The similarity score may be computed by determining a distance or cosine similarity between the respective BNPL loan offering vectors. At operation 810, the similarity scores between the BNPL loan offers are stored in the BNPL loan offer similarity matrix 900, as shown in FIG. 9.

At operation 812, the similarity matrix component 406 identifies, from the historical transaction data, various features of the transactions to be used for feature vector generation. The features may include, for example, a unique identifier for each transaction record, merchant information (e.g., merchant ID, name, location, etc.), transaction amount, product category or description, consumer information (e.g., account, age, gender, etc.), and the like. The similarity matrix component 406 may convert all the categorical data into respective categorical codes. In addition, the similarity matrix component 406 may convert all string data fields to numerical values. The data may be normalized so that wider range values do not have a higher weighted value as compared to narrower range values.

At operation 814, the similarity matrix component 406 generates feature vectors for each transaction record. For example, the normalized feature values for each respective transaction record are stored in a respective transaction record vector.

At operation 816, the similarity matrix component 406 computes a similarity score between each transaction record, using the transaction record vectors. The similarity score may be computed by determining a distance or cosine similarity between the respective transaction record vectors. At operation 818, the similarity scores between the transaction records are stored in the transaction similarity matrix 902, as shown in FIG. 9.

At operation 820, the similarity matrix component 406 stores the BNPL loan offer similarity matrix 900 and the transaction similarity matrix 902, for example, in the database 120 for later retrieval and use.

Referring to FIG. 9, in the example BNPL loan offer similarity matrix 900, the columns and rows represent all BNPL loan offers offered by various IPPs 114, for example, during a specified time period. For example, in an embodiment, the BNPL loan offers are ordered the same and the BNPL loan offer row and column extends from a common origin such that a line of symmetry extends diagonally through the similarity matrix. It is noted that similarity matrix 900 is a symmetric matrix. The entries of the matrix 900 represent cosine similarity scores between the BNPL loan offers. Thus, for example, the entry for the BNPL loan pair loan “0” and loan “1” represents the cosine of an angle between the BNPL loan offering vector of loan “0” and the BNPL loan offering vector of loan “1.” In the example, the value “0.27” in row 0 and column 1 represents that the BNPL loan offer 1 is 27% similar to that of the BNPL loan offer 0.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the phrases “payment card,” “payment device,” “transaction card,” “financial transaction card,” and the like refer to any suitable cashless payment device, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, and/or computers. Each type of payment card can be used as a method of payment for performing a transaction.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A Buy Now, Pay Later (BNPL) offer recommendation service system comprising:
a database storing a BNPL loan offer similarity matrix, a transaction similarity matrix, and historical transaction data, the historical transaction data including a plurality of consumer historical transaction records associated with a plurality of consumers;
at least one processor coupled to the database; and
a memory device storing computer-executable instructions thereon, the computer-executable instructions causing the at least one processor to:
receive, from a computer associated with a merchant, a request for one or more recommended BNPL loan offers, the request associated with a transaction being performed by a consumer;
retrieve, from the database, the BNPL loan offer similarity matrix and the transaction similarity matrix;
retrieve, from the historical transaction data on the database, one or more consumer historical transaction records associated with the consumer, the one or more consumer historical transaction records including only transaction records for transactions performed by the consumer using a BNPL loan offer;
perform a content-based recommendation calculation using the one or more consumer historical transaction records and the BNPL loan offer similarity matrix;
perform an experience-based recommendation calculation using the transaction data, the BNPL loan offer similarity matrix, and the transaction similarity matrix;
produce the one or more recommended BNPL loan offers based on results of the content-based recommendation calculation and the experience-based recommendation calculation; and
transmit the one or more recommended BNPL loan offers to the computer associated with a merchant.

2. The BNPL offer recommendation service system in accordance with claim 1,
the computer-executable instructions further causing the at least one processor, as part of performing the content-based recommendation calculation, to:
determine, from the one or more consumer historical transaction records, previous BNPL loan offers used by the consumer; and
for each of the previous BNPL loan offers used by the similar consumer, determine a similarity score to each of the other offers in the BNPL loan offer similarity matrix.

3. The BNPL offer recommendation service system in accordance with claim 2,
the computer-executable instructions further causing the at least one processor to generate a first ranked list of first similar offers based on the previous BNPL loan offers used by the consumer and the similarity scores.

4. The BNPL offer recommendation service system in accordance with claim 1,
the computer-executable instructions further causing the at least one processor, as part of performing the experience-based recommendation calculation, to determine, from the transaction data, a most used BNPL loan offer used at the merchant; including extracting merchant information from the plurality of consumer historical transaction records.

5. The BNPL offer recommendation service system in accordance with claim 4,
the computer-executable instructions further causing the at least one processor to determine, using the most used BNPL loan offer, an offer similarity score to each of the other offers in the BNPL loan offer similarity matrix.

6. The BNPL offer recommendation service system in accordance with claim 5,
the computer-executable instructions further causing the at least one processor to generate a second ranked list of second similar offers based on the offer similarity scores.

7. The BNPL offer recommendation service system in accordance with claim 6,
the computer-executable instructions further causing the at least one processor to determine, for the transaction being performed by a consumer, a most similar transaction from the plurality of consumer historical transaction records, comprising:
generating a transaction data feature vector for the transaction being performed by a consumer;
computing a transaction similarity score for the transaction being performed by a consumer and each consumer historical transaction record of the plurality of consumer historical transaction records; and
selecting the highest transaction similarity score, the highest transaction similarity score being associated with the most similar transaction.

8. The BNPL offer recommendation service system in accordance with claim 7,
the computer-executable instructions further causing the at least one processor to:
determine, from one or more consumer historical transaction records associated with the most similar transaction, previously used BNPL loan offers; and
for each of the previously used BNPL loan offers, determine a third similarity score to each of the other offers in the BNPL loan offer similarity matrix.

9. The BNPL offer recommendation service system in accordance with claim 8,
the computer-executable instructions further causing the at least one processor to generate a third ranked list of third similar offers based on the previously used BNPL loan offers and the third similarity scores.

10. The BNPL offer recommendation service system in accordance with claim 1,
the computer-executable instructions further causing the at least one processor, as part of producing the one or more recommended BNPL loan offers, to:
filter the results of the content-based recommendation calculation and the experience-based recommendation calculation based on one or more of the following: purchase preferences, lending preferences, personal information, and location data, all of which are associated with the consumer.

11. A computer-implemented method comprising:
receiving, from a computer associated with a merchant, a request for one or more recommended BNPL loan offers, the request associated with a transaction being performed by a consumer;
retrieving, from a database, a BNPL loan offer similarity matrix and a transaction similarity matrix, the database storing the BNPL loan offer similarity matrix, the transaction similarity matrix, and historical transaction data, the historical transaction data including a plurality of consumer historical transaction records associated with a plurality of consumers;
retrieving, from the historical transaction data stored on the database, one or more consumer historical transaction records associated with the consumer, the one or more consumer historical transaction records including only transaction records for transactions performed by the consumer using a BNPL loan offer;
performing a content-based recommendation calculation using the one or more consumer historical transaction records and the BNPL loan offer similarity matrix;
performing an experience-based recommendation calculation using the transaction data, the BNPL loan offer similarity matrix, and the transaction similarity matrix;
producing the one or more recommended BNPL loan offers based on results of the content-based recommendation calculation and the experience-based recommendation calculation; and
transmitting the one or more recommended BNPL loan offers to the computer associated with a merchant.

12. The computer-implemented method in accordance with claim 11,
said operation of performing the content-based recommendation calculation further comprising:
determining, from the one or more consumer historical transaction records, previous BNPL loan offers used by the consumer; and
for each of the previous BNPL loan offers used by the similar consumer, determining a similarity score to each of the other offers in the BNPL loan offer similarity matrix.

13. The computer-implemented method in accordance with claim 12 further comprising:
generating a first ranked list of first similar offers based on the previous BNPL loan offers used by the consumer and the similarity scores.

14. The computer-implemented method in accordance with claim 11,
said operation of performing the experience-based recommendation calculation further comprising determining, from the transaction data, a most used BNPL loan offer used at the merchant; including extracting merchant information from the plurality of consumer historical transaction records.

15. The computer-implemented method in accordance with claim 14,
said operation of performing the experience-based recommendation calculation further comprising determining, using the most used BNPL loan offer, an offer similarity score to each of the other offers in the BNPL loan offer similarity matrix.

16. The computer-implemented method in accordance with claim 15 further comprising:
generating a second ranked list of second similar offers based on the offer similarity scores.

17. The computer-implemented method in accordance with claim 16 further comprising:
determining, for the transaction being performed by a consumer, a most similar transaction from the plurality of consumer historical transaction records, comprising:
generating a transaction data feature vector for the transaction being performed by a consumer;
computing a transaction similarity score for the transaction being performed by a consumer and each consumer historical transaction record of the plurality of consumer historical transaction records; and
selecting the highest transaction similarity score, the highest transaction similarity score being associated with the most similar transaction.

18. The computer-implemented method in accordance with claim 17 further comprising:
determining, from one or more consumer historical transaction records associated with the most similar transaction, previously used BNPL loan offers; and
for each of the previously used BNPL loan offers, determining a third similarity score to each of the other offers in the BNPL loan offer similarity matrix.

19. The computer-implemented method in accordance with claim 18 further comprising:
generating a third ranked list of third similar offers based on the previously used BNPL loan offers and the third similarity scores.

20. The computer-implemented method in accordance with claim 11,
said operation of producing the one or more recommended BNPL loan offers comprising filtering the results of the content-based recommendation calculation and the experience-based recommendation calculation based on one or more of the following: purchase preferences, lending preferences, personal information, and location data, all of which are associated with the consumer.
